(19) United States
(12) Patent Application Publication
(10) Pub. No.: US 2011/0085844 A1
(43) Pub. Date: Apr. 14, 2011

(54) Hand-held soap dispenser and washing device with flexible head

(76) Inventor: Regina Mullins-Schwaebler, Virginia Beach, VA (US)

(21) Appl. No.: 12/587,734

(22) Filed: Oct. 13, 2009

(51) Int. Cl. B05B 9/08

(52) U.S. Cl. 401/261

(57) ABSTRACT

A soap dispenser and cleaning device includes a hollow soap reservoir having an end cap for refilling the reservoir with soap or other cleanser. A flexible neck is arranged at an end of the hollow soap reservoir opposite the end cap and includes a soap delivery channel arranged therein. A sponge holder head attaches to the flexible neck opposite the soap reservoir and includes at least one opening for delivering soap to a sponge attached thereto. The sponge is a resilient fluid communication sponge that delivers a cleanser to an item being washed.

There are no related patent applications.

The present invention did not receive federal research and/or development funding.

### TECHNICAL FIELD

Generally, the present invention relates to a hand-held soap dispensing device for use in washing items such as dishes, silverware, and the like. More specifically, the present invention is a soap dispenser that includes an operating end having a cleansing material such as sponge. The sponge attaches to a soap reservoir via a flexible neck that allows the sponge to be arranged at an angle relative to the reservoir for assisting the user in washing peculiarly shaped items. A back side of the sponge includes a mounting plate with a keyhole opening that accepts lobes or ears which protrude from a distal end of the flexible neck to create a seal between the sponge and the soap reservoir to prevent cleanser from leaking therefrom. That is, the lobes of the neck are inserted into the keyhole between the sponge and mounting plate and rotated several degrees to create a fluid seal between the back side of the sponge and the reservoir.

### BACKGROUND OF THE INVENTION

Cleanser dispensing sponge systems are sold for use in cleaning household items such as dishes. Such systems may comprise an integrated soap reservoir that dispenses soap through a sponge. Typically, such systems include a rigid frame to which the sponge is affixed. Such system is disclosed in Gulker et al., U.S. Pat. No. 4,886,388, which is incorporated herein by reference thereto.

Gulker is formed from a single rigid unit by techniques known in the plastic molding art. Ribs 30 are provided along the handle portion 28 for gripping purposes. Other retaining ribs 50 are provided on vertical support ribs 42 and 44 for securing the sponge 22 to Gulker's device. The Gulker sponge is provided on a rigid support and the sponge cannot be configured such that the overall length of the device may be shorted or elongated. Moreover, the Gulker sponge cannot be arranged at an angle relative to the handle for washing the interior of angled drinking items such as glass boots.

There is a need for a soap dispenser and washing device that may be configured such that the head may be positioned at a desired angle relative to the handle. To that end, the present invention aims to solve this heart-felt need by providing such a device. Thus, it is an aim of the invention to provide a device that may be shortened or lengthened to meet the specific needs of a user, as well as being able to configure the head of the device at various angles relative to the handle.

### SUMMARY OF THE INVENTION

The device includes a handle which includes a reservoir with an access opening for receiving cleanser such as liquid soap. The access opening may comprise a threaded neck for receiving an end cap having complementary threads thereon. The device is orientated with the access opening arranged upward and the end cap is removed when filling it with cleanser.

A head is attached to the handle via a flexible neck that includes a channel having a first end in fluid communication with the reservoir and a second end in fluid communication with at least one opening in the head. A fluid restrictor mechanism may be included between the reservoir and the head. In a preferred embodiment, the restrictor mechanism is a grid of latticework having small holes arranged therein. The head may comprise a sponge or any other known porous cleaning materials that allows cleanser to flow from a back side to a front side and thereafter applied to an item that is being cleaned. The flexible neck comprises a plurality of folds or bellows that may be compressed to create a shorter device or elongated to create a longer device. These folds allow the head to be configured in an infinite plurality of angles relative to the handle for use in cleaning oddly shaped items. At least one pair of radial lobes extends outward from a distal end of the neck opposite the soap reservoir.

The detachable head comprises a strip of cleaning material such as a sponge having a substantially rigid back support or mounting plate that includes an opening which receives cleanser. That is, cleanser delivery openings are arranged within the mounting plate in the restrictor mechanism and are in fluid communication, via the channel arranged within the flexible neck, with the reservoir for delivering cleanser to an attached porous cleaning material such as a sponge. The cleanser permeates the sponge or other porous cleaning material as the head of the device is moved across an item that is being cleansed. The flow restrictor is arranged within the mounting plate or on a back side of the sponge against the mounting plate and comprises a plurality of small openings that are the cleanser delivery openings. The flow restrictor device meters the amount of cleanser that flows from the reservoir into the cleaning material to prevent an inordinate amount of cleanser to freely flow from the reservoir. The size of the openings in the flow restrictor is small enough to prevent a free flow of cleanser through the sponge. That is the cleanser only flows when a sucking action is created by the cleaning material as it is depressed against the item that is being washed.

The head of the device comprises a keyhole opening that is complementary in shape to the radial lobes of the flexible neck to allow the lobes to be inserted into the keyhole opening to create a fluid seal between the head and the reservoir. The keyhole opening may include a raised lip comprising a bulging area into which the radial lobes of the flexible neck are seated between the mounting plate and the back side of the abrasive scrubbing surface of the head. In this manner, the radial lobes of the flexible neck are aligned with the keyhole opening of the head and the two are attached together. As the abrasive nature of the sponge becomes worn down, it is easily replaced with a new sponge in a simplified manner by twisting the head in an opposite direction and withdrawing the radial lobes from within the head to separate the two. A new scrubbing head may be applied by inserting the radial lobes into the new head's keyhole opening and twisting and seating the radial lobes into the raised lip.

It is one object of the invention to provide a cleanser dispensing sponge which contains the cleanser within a reservoir of the handle.

It is another object of the invention to provide a cleanser dispensing sponge without the need to continuously add cleanser to the face of the sponge during a cleaning operation.

A further object of the invention is to provide a cleanser dispensing device comprising a sponge or other scrubbing material that is easy to replace by engaging the lobes of the flexible neck with the keyhole opening.

An additional object is to provide a device that has is relatively inexpensive to produce and intuitively easy to use.

Further objects, features and advantages of the invention will become apparent from a consideration of the following description and the included claims when taken in connection with the previous discussion and the accompanying drawings. The above explanations are provided to illustrate the utility of the invention. And, by no means necessary are these explanations intended to limit the application of this invention from being used for other purposes.

### DESCRIPTION OF THE DRAWINGS

FIG. 1 is a perspective view showing a hand-held soap dispenser and washing device with a sponge mounted to the head of the device.

FIG. 2 is a perspective view of the hand-held soap dispenser and washing device with the sponge and cap removed. In this instance, the bellow region of the flexible neck is fully extended.

FIG. 3 is a side view of the hand-held soap dispenser and washing device and shown with the bellow region of the flexible neck in a collapsed state.

FIG. 4 is a cross section view of the hand-held soap dispenser and washing device.

FIG. 5 is a perspective view of the hand-held soap dispenser and washing device having the bellow region of the flexible neck crooked such that the head assumes an angle relative to the handle.

### DETAILED DESCRIPTION OF THE INVENTION

The following is the preferred embodiment or best mode for carrying out the invention. It should be noted that this invention is not limited by the discussion of the various embodiments and should only be defined by the appended claims. Moreover, it should be recognized that this invention is not limited by the discussion of the preferred embodiments, but that skilled artisans may easily recognize that certain modifications may be made without deviating from the spirit of the invention.

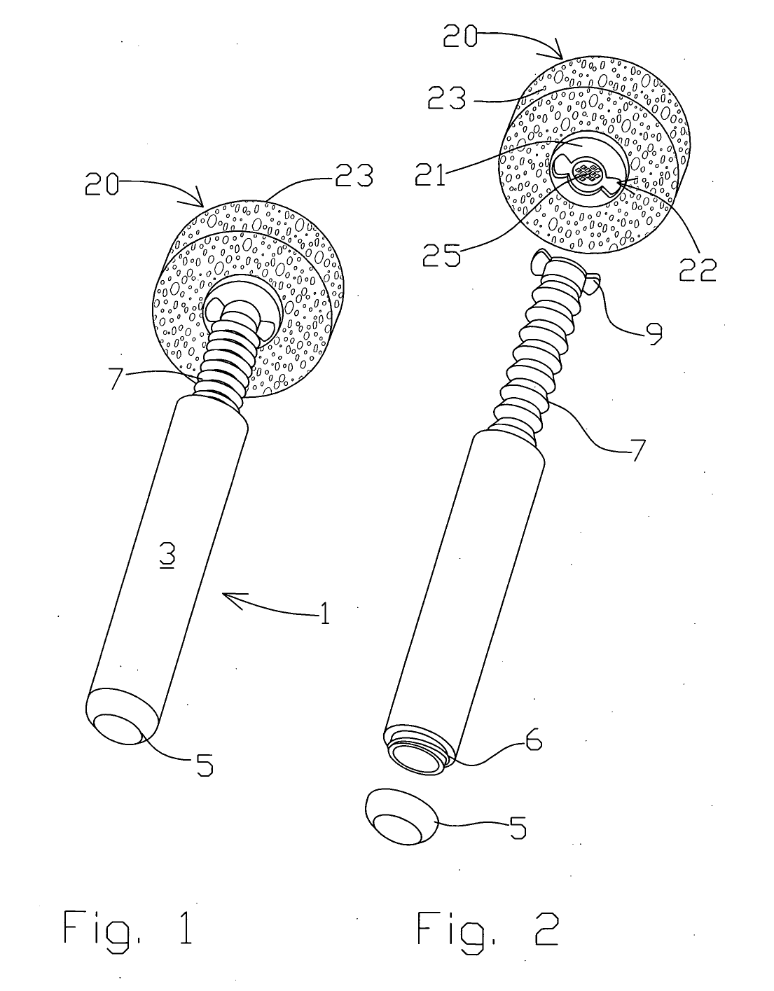

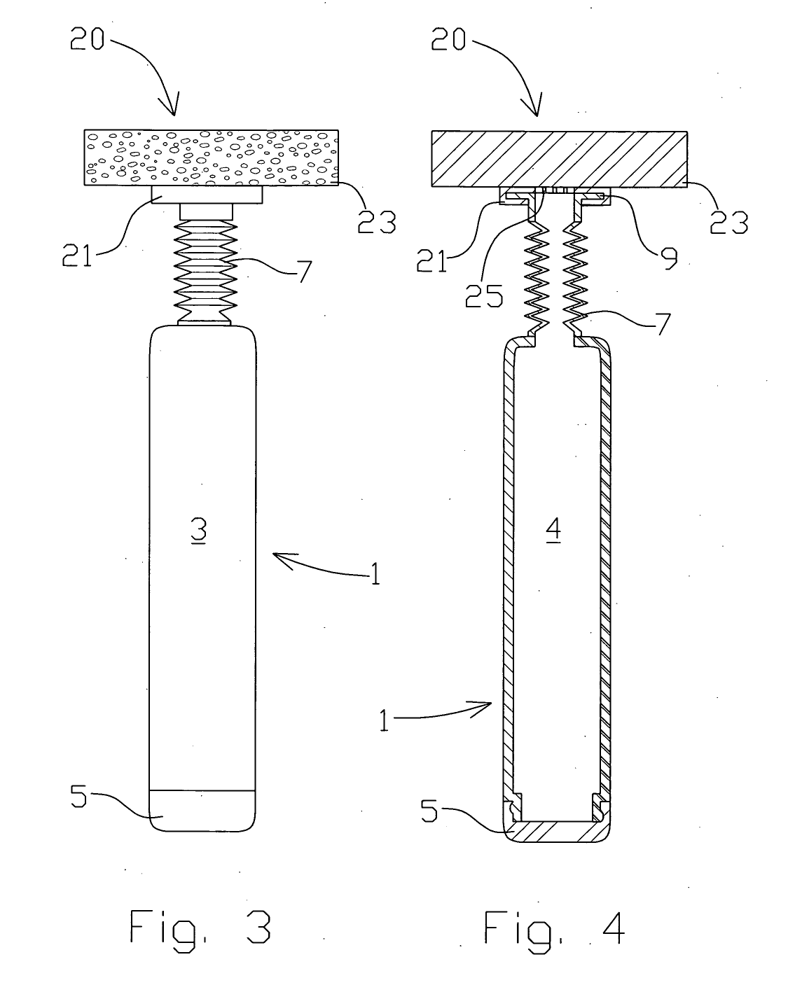

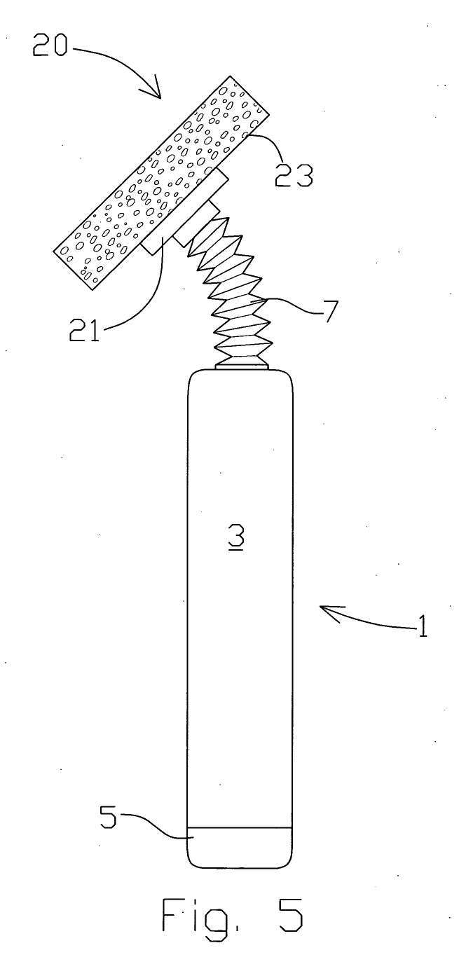

Now referring to the drawings, FIG. 1 is a perspective view of the device 1. A handle 3 defines a reservoir 4 that contains cleanser such as dish soap. Reservoir 4 includes a threaded open end 6 formed at one end thereof and sealed by an end cap 5. End cap 5 includes complementary threads as shown in the cross section view of FIG. 4. As more clearly shown in FIG. 2, the threaded neck 6 that accepts threads of the cap 5 seals the reservoir 4 after cleanser has been deposited into the reservoir 4. A flexible neck 7 is formed at an opposite end of the handle 3 and includes a plurality of bellows or folds that may be collapsed as shown in FIGS. 1, 3, 4 or may be extended as shown in FIG. 2. At least two lobes 9 are formed at an end of the flexible neck 7 opposite the handle 3.

A head 20 is formed and attached to an end of the flexible neck 7 as shown in FIGS. 1, 3-4. The head 20 includes a keyhole opening 22 that mates with the at least one pair of radial lobes 9 provided on an end of the flexible neck 7. Various materials used for implementing the invention may comprise one or more of the following plastics including but not limited to Polyethylene Terephthalate, High Density Polyethylene, Polyvinyl Chloride, Polypropylene, Polystyrene, polyurethanes, polyvinyl chloride and other mixed resins. The back side of the cleanser material 23 includes a mounting plate 21 with the keyhole opening 22 that accepts the lobes or ears 9 which protrude from a distal end of the flexible neck to create a seal between the cleanser material 23 and the soap reservoir 4. That is, the lobes of the neck are inserted into the keyhole between the sponge and mounting plate and rotated several degrees to create a fluid seal between the back side of the porous cleansing material and the reservoir.

In this manner, cleanser or soap deposited into the handle may flow from the reservoir through the flexible neck and into the head. As the porous material or sponge is compressed and released, a suction action is created causing the cleanser to be drawn into the sponge via the aligned through openings of the head and flexible neck. The mounting plate 21 includes a flow restrictor 25 that comprises a lattice of small openings, as shown in FIG. 2, which prevents too much cleanser from flowing through the porous cleanser material 23.

During use, the device is orientated with the access opening arranged upward and the end cap is removed. Cleanser is deposited into the reservoir and the end cap is twisted onto the threaded open end of the reservoir. This cleanser flows from the reservoir through the flexible neck and into the flow restriction device. Openings in the flow restriction device allow only a small portion of the cleanser to flow from the flexible neck into the back side of the porous cleanser material. Thereafter, the cleanser is flowed via capillary action through the cleanser material and deposited onto the item that is being washed. That is, the head is attached to the handle via a flexible neck that includes a channel having a first end in fluid communication with the reservoir and a second end in fluid communication with at least one opening in the head. The fluid restrictor mechanism may be included between the reservoir and the head. The head may comprise a sponge or any other known porous cleaning materials that allows cleanser to flow from a back side to a front side and thereafter applied to an item that is being cleaned.

As can be understood by viewing the various drawings, the flexible neck comprises a plurality of folds or bellows that may be compressed to create a shorter device or elongated to create a longer device. These folds allow the head to be configured in an infinite plurality of angles relative to the handle for use in cleaning various shaped items. FIG. 5 shows the head being arranged at substantially forty-five degrees relative to a plane extending from the end cap through the flexible neck. The at least one pair of radial lobes extends outward from a distal end of the neck opposite the soap reservoir to seal the replaceable head to the flexible neck.

The detachable head comprises a strip of cleaning material such as a sponge having a substantially rigid back support or mounting plate that includes an opening which receives cleanser. In the drawings, the cleanser material is shown as being circular. However, it is understood that the strip of cleanser material may be any shape. The cleanser delivery openings of the fluid restrictor device are arranged within the mounting plate and are in fluid communication, via the channel arranged within the flexible neck, with the reservoir for delivering cleanser to an attached material such as sponge. The flow restrictor device meters the amount of cleanser that flows from the reservoir into the cleaning material to prevent an inordinate amount of cleanser to freely flow from the reservoir. The size of the openings in the flow restrictor is small enough to prevent a free flow of cleanser through the sponge. That is the cleanser only flows when a sucking action is created by the cleaning material as it is depressed against the item that is being washed.

As the abrasive nature of the cleansing material wears out, it is replaced by twisting the head in an opposite direction and withdrawing the radial lobes from within the head to separate the neck from the head. A new scrubbing head may be applied by inserting the radial lobes into the new head's keyhole opening and twisting and seating the radial lobes into the raised lip.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

1. A hand-held soap dispensing and washing device comprising:
a hollow handle forming a reservoir that accepts cleanser, said hollow handle having a first end that is open and through which said cleanser is deposited into the reservoir;
a cap that attaches to the first end of the hollow handle to seal it such that cleanser does not leak from the reservoir;
a flexible neck formed at an end of the hollow handle opposite the first end and having a plurality of bellows surrounding a channel through which cleanser deposited into the reservoir flows;
a pair of lobes formed on the flexible neck;
a head having a front side and a support plate on a back side thereof, said support plate comprising a keyhole opening that accepts the pair of lobes formed on the flexible neck to create a seal between the head and reservoir;
a cleansing material attached to the head having a first face used in performing washing operations and a second face attached to the head, said cleansing material including resilient and fluid conducting properties; and,
a fluid restricting mechanism arranged between the second face of the cleansing material and the reservoir and metering the flow of cleanser to the front face of the cleansing material.

2. The hand-held soap dispensing and washing device of claim 1, further comprising:
a latticework of substantially rigid strips forming openings which allow cleanser to flow from the flexible neck to the cleansing material.

3. The hand-held soap dispensing and washing device of claim 1 formed from material selected from one or more plastics selected from a group consisting of Polyethylene Terephthalate, High Density Polyethylene, Polyvinyl Chloride, Polypropylene, Polystyrene, polyurethanes, polyvinyl chloride and mixed resins.

4. The hand-held soap dispensing and washing device of claim 1 wherein said first end of the reservoir comprises exterior threads formed thereon and the end cap includes complementary interior threads formed therein such that the end cap may be fastened by twisting the end cap onto the exterior threads of the reservoir.

5. The hand-held soap dispensing and washing device of claim 1 wherein said cleansing material is sponge.

6. The hand-held soap dispensing and washing device of claim 5 wherein said sponge is circular in shape.

7. A soap dispensing and washing device comprising:
a handle forming a reservoir that accepts cleanser, said handle having an open end through which said cleanser is deposited into the reservoir;
a cap that attaches to the open end of the handle to seal it such that cleanser does not leak from the reservoir;
a flexible neck attached at an end of the handle opposite the open end and having a plurality of bellows surrounding an interior channel having an end in fluid communication with the reservoir;
a head attached to the flexible neck and having a substantially rigid back plate comprising a keyhole opening; and
a sponge having a first face used in performing washing operations and a second face attached to a front side of the rigid back plate of the head, said sponge including resilient and fluid conducting properties.

8. The soap dispensing and washing device of claim 7 further comprising a fluid restricting mechanism arranged between the sponge and the reservoir and metering the flow of cleanser to the sponge.

9. The soap dispensing and washing device of claim 8 wherein said fluid restricting mechanism comprises a latticework of substantially rigid strips forming openings that allow cleanser to flow from the flexible neck to the sponge.

10. The soap dispensing and washing device of claim 7 formed from material selected from one or more plastics selected from a group consisting of Polyethylene Terephthalate, High Density Polyethylene, Polyvinyl Chloride, Polypropylene, Polystyrene, polyurethanes, polyvinyl chloride and mixed resins.

11. The soap dispensing and washing device of claim 7 wherein said open end of the handle comprises exterior threads formed thereon and the cap includes complementary interior threads formed therein such that the cap may be fastened by twisting the cap onto the exterior threads of the open end of the handle.

12. The soap dispensing and washing device of claim 7 wherein said sponge is circular in shape.

13. A soap dispensing device comprising:
a hollow handle that defines a reservoir, said hollow handle having a first open end and a second open end;
a removable cap attached to the first open end;
a flexible neck attached to the second open end of the hollow handle and defining a fluid channel therein, a pair of lobes extending from an end of the flexible end opposite the second end of the hollow handle; and,
a strip of porous cleaning material having a front side and a back side, said back side including a mounting plate having a keyhole opening with a flow restrictor arranged therein, said keyhole opening accepting the lobes that protrude from the flexible neck to create a seal between the back side of the strip of porous cleaning material and the soap reservoir.

14. The soap dispensing device of claim 13, further a flow restrictor comprising:
a latticework of substantially rigid strips forming openings that allow cleanser to flow from the flexible neck to the cleansing material.

15. The soap dispensing device of claim 13 wherein said flexible neck comprises a plurality of bellows surrounding a channel through which cleanser deposited into the reservoir flows to the strip of porous cleaning material.

16. The soap dispensing device of claim 13 formed from material selected from one or more plastics selected from a group consisting of Polyethylene Terephthalate, High Density Polyethylene, Polyvinyl Chloride, Polypropylene, Polystyrene, polyurethanes, polyvinyl chloride and mixed resins.

17. The soap dispensing device of claim 13 wherein said reservoir comprises exterior threads formed thereon and the removable cap includes complementary interior threads formed therein such that the removable cap may be fastened by twisting the removable cap onto the exterior threads of the reservoir.

18. The soap dispensing device of claim 13 wherein said strip of porous cleansing material is sponge.

19. The soap dispensing device of claim 18 wherein said sponge is circular in shape.

20. The soap dispensing device of claim 13 wherein said flow restrictor comprises a latticework of substantially rigid strips forming openings that allow cleanser to flow from the flexible neck to the strip of porous cleaning material.
